(19) United States
(12) Patent Application Publication
(10) Pub. No.: US 2006/0184680 A1
(43) Pub. Date: Aug. 17, 2006

(54) Location services for unlicensed mobile access

(75) Inventors: Ville Ruutu, Espoo (FI); Jarko Niemenmaa, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/294,362

(22) Filed: Dec. 6, 2005

(30) Foreign Application Priority Data
Feb. 14, 2005 (GB) GB 0503041.6

(51) Int. Cl. G06F 12/00; G06F 15/16

(52) U.S. Cl. 709/229; 711/119

(57) ABSTRACT

There is disclosed an unlicensed mobile access network including a network control element and a network access point, said network being adapted to determine the access and/or tranmission range of a network access point to which a mobile terminal is connected, to determine whether the position of the network access point can be used as an estimate of a location of the mobile terminal, and a method of operation thereof.

### BACKGROUND TO THE INVENTION

1. Field of the Invention

The present invention relates to unlicensed mobile access networks, and more particularly to the provision of location services in such networks.

2. Description of the Related Art

“Unlicensed Mobile Access” (UMA) is a proposal to create a BSS (base station sub-system) look-alike access system architecture for “tunneled GSM” over two existing unlicensed-band radio interfaces: Bluetooth and WiFi (802.11). It is proposed that UMA may be used, for example, for coverage extensions in indoor applications (such as home or office applications) to capture otherwise fixed line traffic for cellular operators. In the US, UMA is perceived as a cheaper way to provide missing coverage to domestic users at home than via a macro network.

There is a current European proposal to use UMA architectures in combination with a GSM (global system for mobile communication) RAN (radio access network), known as a GERAN. The unlicensed mobile access network (UMAN) is proposed to consist of UMA network controllers (UNCs), and access points (APs), which APs conform to a BlueTooth or WiFi standard as appropriate.

A consortium of companies (reference can be made to http://www.umatechnology.org/) have drafted specifications for UMANs. At least some of these UMAN specifications include some discussion of location services (LCS).

The published document “UMA Architecture (Stage 2) R1.0.2” discusses LCS support. Specifically discussed is emergency service support for United States Federal Communications Code (FCC) E911 Phase 2 requirements. A number of ways in which the location of a terminal performing an emergency call may be obtained are discussed (in chapter 9.17.2.1). In one way the UNC may maintain a database of AP locations. The AP location is provided from a terminal via a known URR REGISTER REQUEST/URR REGISTER UPDATE message or via some management interface. In another way the terminal may provide its current location (e.g. obtained via the A-GPS interface) in a URR REGISTER/UPDATE message. In another way the UNC can look up a location database based on a public IP address and/or MAC address of a terminal.

Location services are discussed in chapter 9.18 of the published document “UMA Architecture (Stage 2) R1.0.2”. Cell information (of possibly available GSM coverage) may be used by the UNC to determine the location of a terminal. As another possibility, the AP indentity is mentioned. Cell and AP information can be provided from the terminal to the UNC using URR-REGISTER and URR-REGISTER UPDATE messages.

Likewise, the document “UMA Protocols (Stage 3) R1.0.2” discusses LCS support. URR REGISTER REQUEST and URR REGISTER UPDATE UPLINK messages are identified as including the following information elements (IE) useful for location purposes: AP radio identity; cell identity; Geographic Location; and AP location. AP radio identity IE is used for transmission of Bluetooth Device address (BD_ADDR) or WLAN MAC Address of AP. There is a field called “Type of Identity” which contains only a value “IEEE MAC-address format”. Other values are for future use. A cell identity IE identifies the cellular cell. A geographic location IE can be used to deliver, for example, an A-GPS location estimate from the terminal. An AP location IE is for indicating the location of a terminal or an AP to the network.

There are problems associated with these various proposals. The basic assumption with UMA networks, in relation to LCS, is that the distance between a UMA terminal and an AP is very small, and thus it is possible to utilize the access point identification/coordinates to determine the location information for the UMA terminal.

However, such assumption may lead to various problems. For example, Bluetooth devices can have three transmission powerclasses: Class 1 with maximum transmission power of 100 mW; Class 2 with maximum transmission power of 2.5 mW; and Class 3 with maximum transmission power of 1 mW. Depending on sensitivity, Class 1 can have a maximum range of approximately 100 m, and classes 2 and 3 a range of the order of 10 m.

While for many LCS applications it does not matter if the location is known with 10 m or 100 m, it is easy to envision cases where it is crucial to know this. For example, the US FCC mandated E911 emergency call location requirements demand that 67% of emergency calls must be located with better accuracy than 50 m. In such cases, it is important to know whether the access point information provides location uncertainty of 10 m or 100 m (e.g. if it is uncertain whether an AP gives 10 m uncertainty, then other possibilities for location determination, such as A-GPS, may be tried).

Another example of the importance of location uncertainty information may be in a shopping mall with UMA access. Services like special offers, or guidance, may benefit from 10 m location uncertainty rather than 100 m uncertainty.

Furthermore, there are already solutions that aim at extending the range of 802.11 systems. For example, a US company named Vivato (www.vivato.com) offers a “Vivato 1210 Outdoor Wi-Fi base station” with an integrated phased-array antenna to create directed narrow beams of Wi-Fi transmissions extending coverage. Vivato claims that the outdoor uplink range (assuming outdoor-to-outdoor case, VP1210 at 20 m, 100 mW client with 2.2 dBi antenna at 1.5 m) is as follows: 11 Mbps up to 4.2 km; 5.5 Mbps up to 5.1 km; 2 Mbps up to 6.0 km; 1 Mbps up to 7.2 km. Thus the assumption about a short range between a UMA terminal and an access point is not necessarily valid in all cases.Typically an assumption in UMA is that IEEE 802.11b technologies are used. While this may be valid for now, other, longer range, technologies such as 802.16 (WiMax) or 802.20 can be expected to be used in future. For example 802.16d has theoretical cell size of 50 km with line-of-sight and 10 km with non-line-of-sight. In practice (assuming outdoor antennas) the ranges are perhaps some kms, but even these ranges clearly make an assumption of close proximity of UMA terminals and access points invalid.

As a related problem, currently the UNC does not know details of which kind of physical radio interface is used between the terminal and the AP, such as Bluetooth power class etc. It may even be that the UNC may not be aware of whether a Bluetooth or 802.11 interface is used. The Radio Identity field does not include this information, and unless the UNC can deduce this directly from the Radio Identity values, i.e. it knows the range of values allocated to certain technologies, it cannot determine the type of technology used.

It is an aim of the invention, and embodiments thereof, to provide an improvement to unlicensed mobile access systems which offers improved location services for such systems.

### SUMMARY OF THE INVENTION

The invention provides a method of determining the access range or transmission range of a network access point in an unlicensed mobile access network, comprising transmitting information associated with the access point to a network control element or other associated element. Access range means the maximum possible distance between a network access point and a mobile terminal so that communication between the two is still possible. This range is typically dependent on a maximum supported transmission power of an access point and the mobile terminal, environment, antennas etc. Transmission range is the actual distance between a network access point and a mobile terminal.

The access range may be used to determine whether the location of the access point may be used as an estimate of the location of a mobile terminal wirelessly connected to the access point.

The information associated with the access point may be transmitted from a mobile terminal to the network control element or other associated network element such as a dedicated location server. The information associated with the access point may be transmitted from a network access point to the network control element element or other associated network element.

The information associated with the access point may include the access point type. The information associated with the access point may include the access point access or transmission range. The information associated with the access point may include parameters received at the mobile terminal from the access point. Such parameters may include one or more of a received signal strength measurement; a bit or error frame ratio; or other distance dependent variable. The information associated with the access point may include an estimate of the access or transmission range of the access point determined by the mobile terminal. The information associated with the access point may be an estimate of the distance between the mobile terminal and the access point. The estimate may be calculated by the mobile terminal or the access point. The estimate may be based on a round trip time calculation. When theround trip time estimate is calculated by the mobile terminal, the calculation may include a parameter representing an internal delay of the access point. When the round trip time estimate is calculated by the access point, the calculation may include a parameter representing an internal delay of the mobile terminal.

The information associated with the access point may be included in one or more new information elements in a message transmitted from the mobile terminal. The information associated with the access point may be included in one or more modified information elements in a message transmitted from the mobile terminal. The information associated with the access point may be included in an information element of a URR REGISTER RQUEST message and/or a URR REGISTER UPDATE message.

The information associated with the access point may be included in one or more new information elements in a message transmitted from the access point. The information associated with the access point may be included in one or more modified information elements in a message transmitted from the access point.

The invention further provides a mobile terminal for connection to a network access point of an unlicensed mobile access network, which mobile terminal is adapted to include a transmitter for transmitting information associated with the network access point to a network control element or associated netwrk element.

The information associated with the network access point is preferably indicative of a transmission or access or transmission range of the network access point. The access or transmission range may be used to determine whether the location of the access point may be used as an estimate of the location of a mobile terminal wirelessly connected to the access point.

The mobile terminal may be adapted to receive the information associated with the access point from the access point, or to derive such information from signals received from the access point. The mobile terminal may receive information identifying the access point type. The mobile terminal may receive information identifying the access point access or transmission range. The mobile terminal may measure parameters received from the access point. Such parameters may include one or more of a received signal strength measurement; a bit or error frame ratio; or other distance dependent variable. The mobile terminal may be adapted to determine an estimate of the transmission range of the access point. The information associated with the access point may be an estimate of the distance between the mobile terminal and the access point. The estimate may be calculated by the mobile terminal. The estimate may be based on a round trip time calculation. The calculation may include a parameter representing an internal delay of the access point.

The mobile terminal may be adapted to transmit the information associated with the access point in one or more new information elements of a message. The mobile terminal may be adapted to transmit the information associated with the access point in one or more modified information elements of a message. The mobile terminal may be adapted to transmit the information associated with the access point in an information element of a URR REGISTER RQUEST message and/or a URR REGISTER UPDATE message.

The invention still further provides a network access point of an unlicensed mobile access network, which network acces point is adapted to include a transmitter for transmitting information associated with the network access point range to a network control element or associated network element.

The access or transmission range may be used to determine whether the location of the access point may be used as an estimate of the location of a mobile terminal wirelessly connected to the network access point.

The access point may be adapted to transmit the information associated with the access or transmission range in one or more new information elements of a message. The access point may be adapted to transmit the information associated with the access or transmission range in one or more modified information elements of a message.

The invention yet still further provides a network control element of an unlicensed mobile access network, which network control element is adapted to include a receiver for receiving information associated with a network access point range.

The invention yet still further provides a network element associated with a network control element of an unlicensed mobile access network, which network element is adapted to include a receiver for receiving information associated with a network access point range.

The invention provides an unlicensed mobile access network including a network control element and a network access point, said network being adapted to determine the access or terminal range of a network access point to which a mobile terminal is connected, to determine whether the position of the network access point can be used as an estimate of a location of the mobile terminal.

### BRIEF DESCRIPTION OF THE FIGURES

The invention is described by way of example with reference to the accompanying figure in which:

FIG. 1 illustrates a proposed unlicensed mobile access architecture in which the invention and embodiments thereof may be implemented.

### DESCRIPTION OF THE PREFERRED EMBODIMENTS

The invention is described herein by way of example with reference to a number of embodiments. The invention is described in the context of an unlicensed mobile access system operating in conjunction with a licensed mobile access system, and specifically, in exemplary embodiments, a GERAN system.

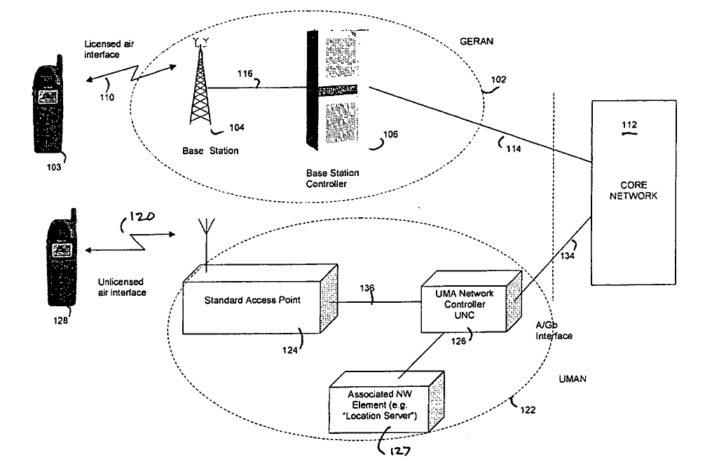

With reference to FIG. 1, there is shown a GERAN 102 including at least one base station 104 and at least one base station controller 106. A mobile terminal 108 is connected, via a licensed air interface 110, to the base station 104 of the GERAN 102. The base station 104 is connected to the base station controller 106 via a communication link 116. The base station controller 106 is connected to a core network 112 via an A/Gb interface connection 114.

With further reference to FIG. 1, there is shown a UMA 122 including at least one standard access point 124, or network access point, and at least one UMA network controller (UNC) 126, or network control element. A mobile terminal 128, being a UMA terminal, is connected, via an unlicensed air interface 120, to the standard access point 124 of the UMAN 122. The standard access point 124 is connected to the UNC 126 via a communication link 136. The UNC 126 is connected to the core network 112 via an A/Gb interface connection 134. An associated network element 127, associated with the UNC 126, such as a location server, is illustrated inm FIG. 1.

The architecture of network arrangements as illustrated in FIG. 1 is known to those skilled in the art. It should be noted that the mobile terminals 108 and 128 are preferably configured to connect in either a GERAN or a UMAN, in accordance with available network coverage and implementation requirements.

The invention generally provides an enhancement to the UMA so that a UMA terminal and/or a UMA access point may provide information from which or based on which the uncertainty of location information can be estimated.

In a first embodiment the invention proposes that the UMA terminal 128 transmits information about the type of access point 124, to which it is connected into the UMAN 122, to the UNC 126. As such the UNC 126 may estimate a maximum possible range between the terminal 128 and the access point 124, and thus estimate the location uncertainty if using the access point location as an estimate for terminal location. The information from the terminal may: (a) identify the access point type (e.g. Bluetooth, 802.11, and in the future other possibilities such as 802.16 or non-802.xx techniques); and/or (b) indicate details of the access point which enble determination of the maximum range of the “cell” provided by the access point, such as the Bluetooth power class.

A possible implementation of the first embodiment is for an existing Radio Identity Information Element (IE) to be enhanced by adding a new field indicating the access point technology type. An additional new field may indicate the power class, if applicable in the implementation.

The access point type and charactersitics thereof may be derived by the UMA terminal based on information contained in signals transmitted from the access point. The access point type and characteristics may be provided by the access point itself to the UNC.

In general, and in all embodiments, the determination of the uncertainty of the UMA location based on the access or transmission range may be made in the UNC 126 and/or associated network element and/or in the core network 112.

It should be noted that the preference of the various embodiments is to determine the range of an access point, so that it can be determined whether such range allows for the location of the access point to be used as a location of the UMA terminal.

An alternative possible implementation of the first embodiment is for a new IE to be added to the known URR REGISTER REQUEST and/or URR REGISTER UPDATE UPLINK messages. This new IE (which may, for example, be called a “Physical Connection” information element) may contain a field indicating the AP technology type, and if applicable the power class.

In a second embodiment the invention proposes that the UMA terminal 128 may deliver details of the radio signal received from the access point 124 to the UNC 126, which details help to estimate the (transmission) range between the terminal 128 and the access point 124. Such information may be, for example, one or more of: the received signal strength measured at the UMA terminal 128; the bit or frame error ratios of the signals received at the UMA terminal 128; or some other variables measured at the UMA terminal that are expected to be dependent on the distance of the UMA terminal from the access point.

A possible implementation of the second embodiment is for a new IE to be added to the known URR REGISTER REQUEST and/or URR REGISTER UPDATE UPLINK messages. This new IE (which may be called, for example, “Radio Details”) may contain a field indicating received signal strength or similar measurements.

The first and second embodiments may be combined to provide an improved implementation. A possible implmentation of the combined first and second second embodiments is for a new IE to be added to the URR REGISTER REQUEST and/or the URR REGISTER UPDATE UPLINK messages. This new IE may contain, at least, fields indicating AP technology type, power class (if applicable), and received signal strength or similar measurements.

In a third embodiment the invention proposes that the UMA terminal 128 can itself make an estimate of the maximum or actual range between it and the access point 124 based on available information, such as information from the access point 124 and details of received radio signals, and deliver this estimate to the UNC.

Thus whereas in the second embodiment the UMA terminal 128 provides measure or received parameters to enable location estimates to be made, for example, by the UNC 126 and/or the core network 112, in the third embodiment the UMA terminal 128 may make the location and/or range estimate itself, and deliver such estimate to the UNC 126 and/or associated network element and/or the core network 112.

A possible implementation of the third embodiment is to provide a new IE added to the known URR REGISTER REQUEST and/or URR REGISTER UPDATE UPLINK messages. This new IE (which may be called, for example, the “Range Estimate”) may contain an estimate of the maximum distance range between the terminal and the access point. It may also contain an indication of the reliability of this estimate (e.g. reliable/non-reliable, or a percentage of reliability).

In a fourth embodiment the invention proposes that the UMA access point and UMA terminal may be enchanced so that they can support some measurement functionality that helps to estimate the distance between the UMA terminal and the UMA access points. Such measurement functionality may be, for example, similar to the Round Trip Time (RTT) functionality implemented in 3GPP UTRAN.

In a first alternative of the fourth embodiment the UMA access point estimates the RTT, i.e. the back-and-forth time delay, for messages between it and the terminal. This is the delay between the transmission of a message and the reception of the corresponding response message from the terminal. Together with indications from the terminal about its internal delays, i.e. the delay in the terminal between the reception of the message from the access point and the transmission of the corresponding response message, the distance can be estimated. This is similar to the arrangement in 3GPP UTRAN.

A possible implementation of the first alternative of this fourth embodiment is for two new IEs to be added to the known URR REGISTER REQUEST and/or URR REGISTER UPDATE UPLINK messages. These new IEs (which may, for example, be called “RTT” and “mobile delay”) may contain the information of round trip time, and the internal delay caused by the UMA mobile. This approach assumes that the access point sends RTT to the terminal. Another option is that the “mobile delay” IE is reported in the URR REGISTER REQUEST and/or the URR REGISTER UPDATE UPLINK messages, and the RTT is sent in a new message from the access point to the UNC.

In a second alternative of the fourth embodiment the UMA terminal estimates the RTT, and the UMA access point estimates its internal delays.

A possible implementation of the second alternative of this fourth embodiment is for two new IEs to be added to URR REGISTER REQUEST and URR REGISTER UPDATE UPLINK messages. These new IEs (which may for example be called “RTT” and “access point delay”) contain the information of round trip time and internal delay caused by the access point. This approach assumes that the access point sends its internal delay to the terminal. Anther option is that “RTT” IE is reported in the URR REGISTER REQUEST and/or the URR REGISTER UPDATE UPLINK messages, and the access point delay is sent in a new message from the access point to the UNC.

In practice the fourth embodiment requires changes in the access points. The first to third ambodiments do not reuire changes in the access points. The fourth embodiment may also require changes at an access technology level (i.e. Bluetooth or 802.11).

Preferably the combination of the first and second embodiments may be implemented together; the third embodiment provides an alternative solution, and the fourth embodiment provides a further alternative solution. However each of the embodiments may, in practice, be implemented either alone or in combination with any other embodiment.

It should be noted that whilst the invention as described herein suggests implementation of an unlicensed mobile access network using BlueTooth or IEEE 802.xx technologies, the invention is not limited to such and may encompass any access technology. Similarly the invention is not limited to use with any licensed access technology.

In general, the invention provides for a technique for a network control element, and/or associated network element and/or a core network, to determine a transmission range or access range associated with a network access point. In dependence thereon, it is determined if such access or transmission range represents an acceptable resolution for determining a location of a mobile terminal. In dependence on such, and if such an access or transmssion range is acceptable, a known position of an access point can be used as an estimate for a position of a mobile terminal connected to the access point.

The access range described herein defines the maximum range of an access point, i.e. the maximum distance between a terminal and the access point at which communication is still possible. The transmission range is an stimate of the actual distance between a terminal and the access point. This can be estimated, as for example described herein, from round trip time measurements or received signal strength measurements.

The information transmitted in various embodiments of the invention may be generally considered to be information associated with a network access point. In some embodiments, this information may be considered as associated with a network access point type.

Although in preferred embodiments the network controller, i.e. the UNC, receives the access range and/or the transmission range information, in alternative arrangements this information may be received by a serving mobile location centre associated with the core network, or by a UMAN network element associated with the UNC, which element may provide locations services.

It should be noted that referecens herein to a terminal, a mobile station, and a mobile terminal are interchangable.

The invention, and embodiments thereof, provide for various advantages and improvements to the art. These advantages include improved location information. The uncertainty of location information can be estimated. Potential large location estimation errors due to invalid assumption of proximity of a terminal to an access point are avoided. Easy implementation is. allowed for. No new hardware is needed.

Various modifications to the described embodiments will be understood by one skilled in the art. The scope of protection afforded by the invention is defined by the appended claims.

1. A method of determining access or transmission range of a network access point in an unlicensed mobile access network, the method comprising:
transmitting information associated with the access point to a network control element, an associated network element or a core network.

2. The method according to claim 1, further comprising using the access or tranmission range to determine whether the location of the access point may be used as an estimate of a location of a mobile terminal wirelessly connected to the network access point.

3. The method according to claim 1, further comprising transmitting information associated with the access point from a mobile terminal to the network control element, an associated network element or the core network.

4. The method according to claim 1, further comprising:
transmitting information associated with the access point from the network access point to the network control element, an associated network element or a core network.

5. The method according to claim 1, wherein the information associated with the access point includes an access point type.

6. The method according to claim 1, wherein the information associated with the access point includes an access point range.

7. The method according to claim 1, wherein the information associated with the access point includes parameters received at a mobile terminal from the access point.

8. The method according to claim 7, wherein the parameters include one or more of a received signal strength measurement, a bit or error frame ratio,and other distance dependent variable.

9. The method according to claim 1, wherein the information associated with the access point includes an estimate of the transmission range of the access point determined by a mobile terminal.

10. The method according to claim 1, wherein the information associated with the access point includes an estimate of a distance between a mobile terminal and the access point.

11. The method according to claim 10, wherein the estimate is calculated by the mobile terminal or the access point.

12. The method according to claim 10, wherein the estimate is based on a round trip time calculation.

13. The method according to claim 10, in which the round trip time estimate is calculated by the mobile terminal, wherein the calculation further includes a parameter representing an internal delay of the access point.

14. The method according to claim 10, in which the round trip time estimate is calculated by the access point, wherein the calculation further includes a parameter representing an internal delay of the mobile terminal.

15. The method according to claim 1, wherein the information associated with the access point is included in one or more new information elements in a message transmitted from a mobile terminal.

16. The method according to claim 1, wherein the information associated with the access point is included in one or more modified information elements in a message transmitted from a mobile terminal.

17. The method according to claim 1, wherein the information associated with the access point is included in an information element of a URR REGISTER REQUEST message and/or a URR REGISTER UPDATE message.

18. The method according to claim 1, wherein the information associated with the access point is included in one or more new information elements in a message transmitted from the access point.

19. The method according to claim 1, wherein the information associated with the access point is included in one or more modified information elements in a message transmitted from the access point.

20. A mobile terminal for connection to a network access point of an unlicensed mobile access networkthe mobile terminal comprising: a transmitter for transmitting information associated with the network access point to a network control element, an associated network element or core network.

21. The mobile terminal of claim 20, wherein the information associated with the network access point is indicative of a transmission or access range of the network access point.

22. The mobile terminal of claim 21, wherein the access range is used to determine whether a location of the access point is used as an estimate of a location of a mobile terminal wirelessly connected to the access point.

23. The mobile terminal of claim 20, configured to receive the information associated with the access point from the access point, or to derive such information from signals received from the access point.

24. The mobile terminal of claim 20, configured to receive information identifying the access point type.

25. The mobile terminal of claim 20, configured to receive information identifying a access point range.

26. The mobile terminal of claim 20, configured to measure parameters received from the access point.

27. The mobile terminal of claims 20, configured to determine an estimate of a transmission range of the access point.

28. A network access point of an unlicensed mobile access network, the network access point comprising:
a transmitter for transmitting information associated with the at least one of the network access and a transmission range to a network control element, an associated network element or a core network.

29. A network access point according to claim 28, wherein at least one of the access and transmission range, is used to determine whether the location of the access point may be used as an estimate of a location of a mobile terminal wirelessly connected to the network access point.

30. A network access point according to claim 28, configured to transmit at least one of the information associated with the access and transmssion range in one or more new information elements of a message.

31. A network access point according to claim 28, configured to transmit the at least one of the information associated with the access and transmission range in one or more modified information elements of a message.

32. A network control element of an unlicensed mobile access network, the network control element comprising: a receiver for receiving information associated with at least one of a network access and transmission range.

33. An unlicensed mobile access network comprising: a network control element; and a network access point, wherein said network is configured to determine at least one of the access and transmission range of a network access point to which a mobile terminal is connected, to determine whether a position of the network access point can be used as an estimate of a location of the mobile terminal.

34. A network element associated with a network control element of an unlicensed mobile access network, the network element comprising: a receiver for receiving information associated with at least one of a network access and transmission range.
